(19) United States
(12) Patent Application Publication
(10) Pub. No.: US 2020/0300161 A1
(43) Pub. Date: Sep. 24, 2020

(54) POSITION SECUREMENT OF AN EXHAUST GAS TURBOCHARGER HOUSING

(71) Applicant: MAN Energy Solutions SE, Augsburg (DE)

(72) Inventors: Stefan ROST, Augsburg (DE); Sebastian SPENGLER, Wehringen (DE); Boris THASER, Augsburg (DE); Santiago UHLENBROCK, Grafenberg (DE); Stefan WEIHARD, Augsburg (DE); Claudius WURM, Augsburg (DE)

(21) Appl. No.: 16/802,890

(22) Filed: Feb. 27, 2020

(30) Foreign Application Priority Data
Mar. 20, 2019 (DE) 10 2019 107 093.7

(51) Int. Cl. F02C 6/12; F04D 29/28

(52) U.S. Cl. CPC F02C 6/12; B33Y 80/00; F04D 29/28

(57) ABSTRACT

A turbocharger having a housing and a stator. The housing and/or the stator has an inner and an outer housing component. An inner section of the housing component lies directly against and covers a lateral section of the housing component. The lateral section and the inner section are formed such that they form a positive-locking connection, which fixes the inner housing component and the outer housing component against positional change along a longitudinal axis of the turbocharger and/or against a rotation about this longitudinal axis. The inner housing component and/or the outer housing component is at least partly produced by additive manufacturing.

### BACKGROUND OF INVENTION

### 1, Field of the Invention

The invention relates to a turbocharger having an integrated position securement of a housing and to a method for producing such a turbocharger.

### 2. Description of Related Art

Major forces act on components of an exhaust gas turbocharger because of rotating components. In order to secure the housing and stator components of turbochargers against a rotation and an axial displacement, additional components and connecting elements, such as dowel pins or screws are generally required. Because of the further components, the number of parts increases substantially, which leads to an expensive installation and a high material expenditure.

### SUMMARY OF THE INVENTION

An object of one aspect of the present invention is to provide a turbocharger having an integrated position securement of a housing and a method for producing such a turbocharger, which reduces the installation expenditure and the number of parts.

According to one aspect of the invention, a turbocharger having a housing and at least one stator is proposed. The housing and/or the stator comprises or comprise an inner housing component and an outer housing component, with which an inner section directly lies against a lateral portion of the inner housing component and covers the lateral portion. The respective lateral portion and the respective inner portion are formed such that together they form a positive-locking connection, which fixes the respective inner housing component and the respective outer housing component against a relative positional change relative to one another along a longitudinal axis of the turbocharger and/or against a rotation about this longitudinal axis. Furthermore, the respective inner housing component and/or the respective outer housing component is at least partly produced by additive manufacturing. By using additive manufacturing methods such as a 3D printing method, the position securement can be directly integrated in the components. Advantageous in this is for example that the component number is reduced and, as a consequence, the weight of the turbocharger and the production costs are also lowered. In addition to this, installation errors can be avoided by way of a positive-locking connection. Altogether, the installation and maintenance expenditure is optimised because of lighter and/or segmented components. Through the positive-locking connection, the containment safety and thus the product safety of the turbocharger improve additionally.

Preferentially, the turbocharger is designed so that the lateral section of an inner housing component and/or the inner section of an outer housing component are produced or were created entirely by additive manufacturing. This is particularly favourable since the forces, against which a position securement is employed, act on the lateral sections of the two housing components. In this way, the position securement can be exactly matched to the requirements of the respective turbocharger.

In an advantageous embodiment version it is provided that the lateral section comprises at least one positioning element that projects from the lateral section. In addition, the inner section comprises at least one recess, which is formed corresponding to the positioning element, so that together these form a positive-locking connection. In an exemplary embodiment of the invention it is provided that the positioning element is formed as a positioning lug and the recess as a groove. Further, an embodiment is favourable in which the positioning elements are formed as at least one spline and the recesses as at least one spline hub. In a further advantageous version it is provided according to the invention that the positioning element is partly or entirely formed as a wavy spline and the recess as a wavy spline hub.

By integrating positioning elements in the housing components, these can be fixed relative to one another in a circumferential direction. Additional connecting elements, such as dowel pins or screws can be omitted because they are no longer necessary. By shaping and arranging the individual positioning elements, an exact and unambiguous orientation of the housing components can be defined besides the position securement, as a result of which errors during the installation can be avoided.

The turbocharger according to one aspect of the invention is formed in an embodiment version so that a plug-turn connection or a bayonet connection is integrated in the lateral section and the inner section, which establishes a positive-locking connection between the inner housing component and the outer housing component. By integrating positioning elements in the housing components, these can be fixed in a longitudinal direction relative to one another.

Furthermore, the measures for the position securement described above can have positive effects on the containment safety for example in the case of a moving blade loss or rotor bursting. Thus, the shearing load screws of a containment-relevant flange connection can be prevented in that the torsional forces resulting from the failure are directly transmitted via the positive-locking connection of the components.

Furthermore it is advantageous when the inner housing component and/or the outer housing component is or are segmented and it is provided, furthermore, in a further development of the present turbocharger that hollow spaces are integrated in the inner housing component and/or the outer housing components. By dividing the components into segments and/or the specific introduction of hollow spaces, the installation and the maintenance expenditure can be reduced in particular in large turbochargers by way of a lower individual weight resulting from this. The segmenting or introduction of hollow spaces can be combined with the measures described above.

In a preferred embodiment of the invention, crash elements or a honeycomb structure for absorbing potential or kinetic energy of components during a component failure are integrated in the inner housing component and/or the outer housing component. Advantageous in this is that the crash elements or the honeycomb structure are directly integrated in the safety-relevant components. In this way, the crash elements or the honeycomb structure reduce the kinetic energy of the rotor fragments emitted in the event of a failure upon impacting on the housing structure by way of targeted deformation. Because of this, escaping of failing components from the turbocharger housing is prevented.

According to one aspect of the invention, a method for producing a turbocharger described above is proposed in which the inner housing component and/or the outer housing component are produced at least partly or entirely by additive manufacturing in particular by a 3D printing method. By an additive manufacture, the inner housing component and the outer housing component can be exactly matched to the requirements of the optimal position securement. For this reason, the installation expenditure, the weight and the costs of the turbocharger can be reduced and an adequate containment safety ensured at the same time.

In a preferred embodiment of the method, the lateral section and/or the inner section are entirely produced by additive manufacturing in particular by a 3D printing method. Particularly favourable in this is that the forces against which a position securement is employed act against the lateral portions of the two housing components. Thus, the position securement can be exactly matched to the requirements of the respective turbocharger.

### BRIEF DESCRIPTION OF THE DRAWINGS

Other advantageous further developments of the invention are marked in the subclaims or are shown in more detail by way of the figures together with the description of the preferred embodiment of the invention. It shows:

FIG. 1 is a sectional view of turbocharger housing with a positioning lug;

FIG. 2 is a sectional view of a turbocharger housing with a spline shaft seat;

FIG. 3 is a sectional view of a turbocharger housing with a bayonet closure;

FIG. 4 is a sectional view of a segmented turbocharger housing with a spline shaft seat; and

FIG. 5 is a sectional view of a turbocharger housing with integrated crash elements.

### DETAILED DESCRIPTION OF THE PRESENTLY PREFERRED EMBODIMENTS

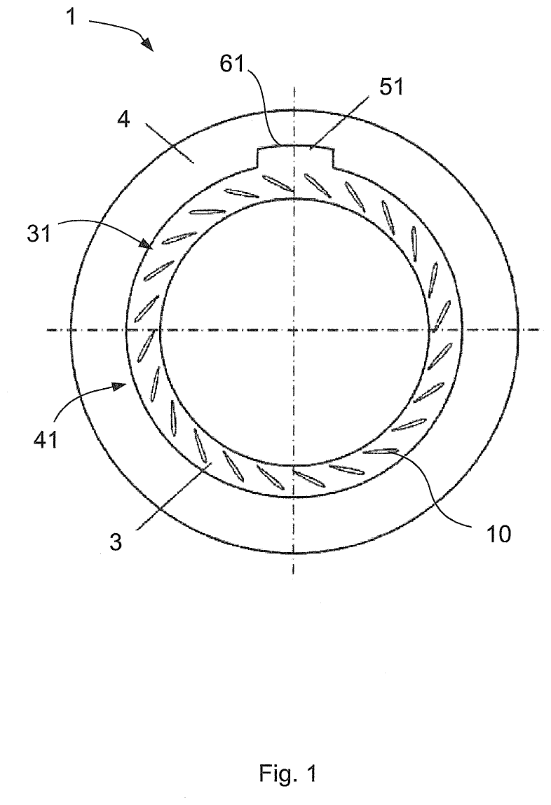

In FIG. 1, a sectional view of a housing 1 of a turbocharger with a positioning lug 51 is shown. The housing 1 comprises an inner housing component 3 and an outer housing component 4. An inner portion 41 of outer housing component 4 is directly against a lateral section 31 of the inner housing component 3 and covers the lateral section 31. The lateral section 31 and the inner section 41 are entirely produced by additive manufacturing. By this manufacturing method, the positioning lug 51, which projects from the lateral section 31, is formed on the lateral section. According to the positioning lug 51, a recess as a groove 61 is formed on the inner section 41. Consequently, the lateral section 31 and the inner section 41 together form a positive-locking connection that fixes the inner housing component 3 and the outer housing component 4 against a relative positional change relative to one another against a rotation about a longitudinal axis.

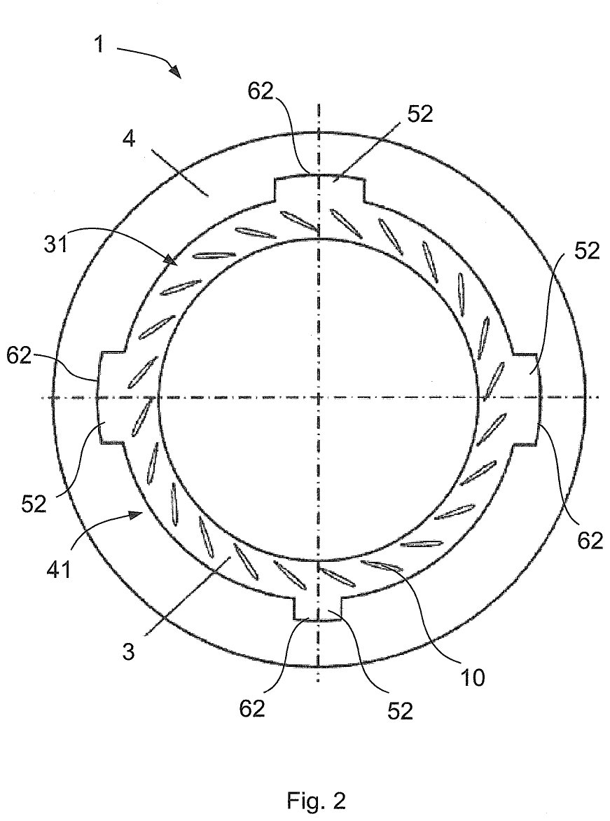

FIG. 2 shows a sectional view of a housing 1 of a turbocharger according to FIG. 1 with alternative positioning elements. The positioning elements are formed as four splines 52 and the recesses as four spline hubs 62. The splines 52 and the spline hubs 62 are evenly distributed over the circumference, wherein the, in the view of FIG. 2, lower spline 52 is formed with lesser width.

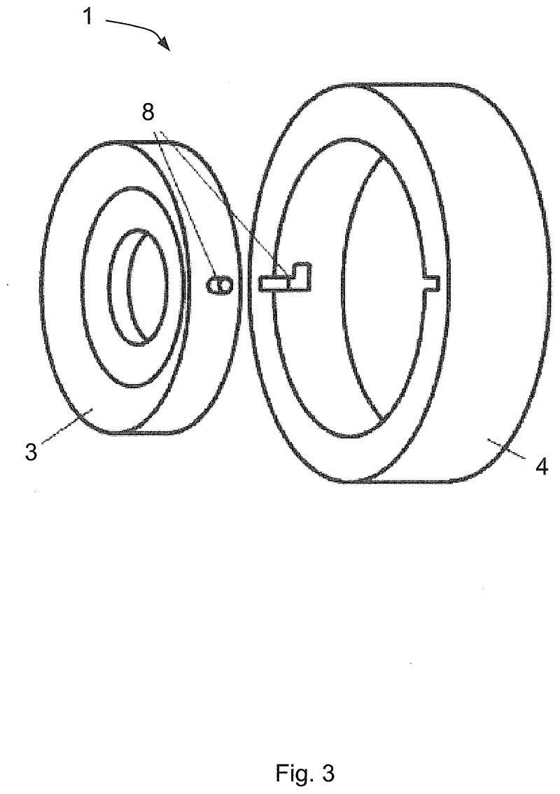

A sectional view of a turbocharger housing 1 with a bayonet closure 8 is shown in FIG. 3. The bayonet closure 8 is integrated in the lateral section 31 and the inner portion 41 and constitutes a positive-locking connection between the inner housing component 3 and the outer housing component 4. Together, they form a positive-locking connection, which fixes the inner housing component 3 and the outer housing component 4 against a relative positional changes relative to one another along a longitudinal axis of the turbocharger.

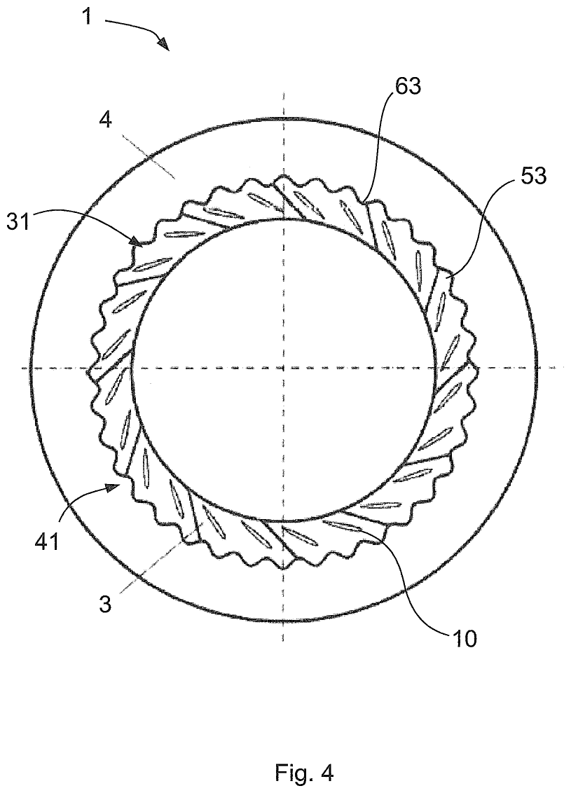

FIG. 4 shows a sectional view of a housing 1 of a turbocharger according to FIG. 1 with a further alternative positioning element. The lateral section 31 of the inner housing component 3 is formed as a wavy spline 53 or a wavy spline arrangement and the inner section 63 as a wavy spline hub 63. Both the wavy spline 53 and also the wavy spline hub 63 fully extend about the lateral section 31 and the inner section 41 respectively. In addition to this, the inner housing component 3 is segmented.

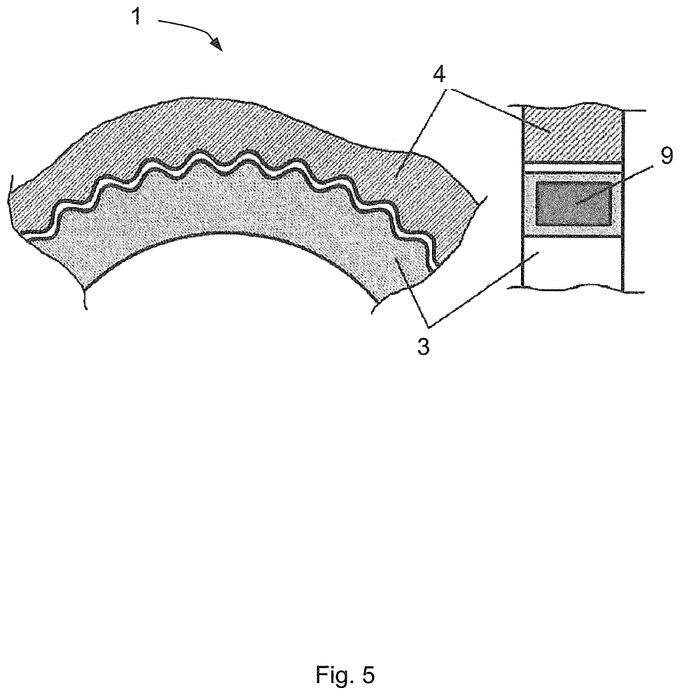

FIG. 5 shows a sectional view of a turbocharger housing 1 with crash elements 9. The crash elements 9 are formed in an energy-absorbing manner and are integrated in the inner housing component 3 for absorbing in particular kinetic energy of components upon a component failure. The position securement in this case is realized with a wavy spline 53 and a wavy spline hub 63.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A turbocharger, comprising:
a housing;
at least one stator;
wherein at least the housing and/or the at least one stator comprise or comprises:
an inner housing component having a lateral section; and
an outer housing component, an inner section of the outer housing component directly lies against the lateral section of the inner housing component and covers the lateral section,
wherein a respective lateral section and a respective inner section are formed such that together they form a positive-locking connection that fixes the inner housing component and the outer housing component against a relative positional change relative to one another along a longitudinal axis of the turbocharger and/or against a rotation about the longitudinal axis, and
wherein the respective inner housing component and/or the respective outer housing component are at least partly produced by additive manufacturing.

2. The turbocharger according to claim 1, wherein the lateral section of the inner housing component and/or the inner section of the outer housing component is manufactured entirely by the additive manufacturing.

3. The turbocharger according to claim 1, wherein
the lateral section comprises at least one positioning element that projects from the lateral section, and
the inner section comprises at least one recess corresponding to the at least one positioning element so that together these form the positive-locking connection.

4. The turbocharger according to claim 3, wherein the at least one positioning element is a positioning lug and the at least one recess is a groove.

5. The turbocharger according to claim 3, wherein the at least one positioning element is at least one spline and the at least one recess is at least one spline hub.

6. The turbocharger according to claim 3, wherein the at least one positioning element is partly or entirely formed as a wavy spline and the at least one recess is a wavy spline hub.

7. The turbocharger according to claim 1, wherein a plug-twist closure or a bayonet closure is integrated in the lateral section and the inner section, which establishes a positive-locking connection between the inner housing component and the outer housing component.

8. The turbocharger according to claim 1, wherein at least one of the inner housing component and the outer housing component is segmented.

9. The turbocharger according to claim 1, wherein hollow spaces are integrated in at least one of the inner housing component and the outer housing component.

10. The turbocharger according to claim 1, wherein crash elements configured to absorb kinetic energy of components in an event of a component failure are integrated in at least one of the inner housing component and the outer housing component.

11. The turbocharger according to claim 1, wherein the crash elements are a honeycomb structure.

12. A method for producing a turbocharger having an inner housing component having a lateral section; and an outer housing component, an inner section of the outer housing component directly lies against the lateral section of the inner housing component and covers the lateral section, comprising:
at least partly producing the inner housing component by additive manufacturing; and
at least partly producing the outer housing component by the additive manufacturing.

13. The method for producing a turbocharger according to claim 12, wherein the lateral section and/or the inner section are entirely produced by the additive manufacturing.

14. The method for producing a turbocharger according to claim 12, wherein the additive manufacturing is a 3D printing method.
